(19) United States
(12) Patent Application Publication
(10) Pub. No.: US 2013/0332369 A1
(43) Pub. Date: Dec. 12, 2013

(54) LEVERAGING ANALYTICS TO PROPOSE CONTEXT SENSITIVE WORKFLOWS FOR CASE MANAGEMENT SOLUTIONS

(71) Applicant: INTERNATIONAL BUSINESS MACHINES CORPORATION, ARMONK, NY (US)

(72) Inventors: VIVEK K. PARAMASHIVAPPA, BANGALORE (IN); BALUNAINI PRASAD, BANGALORE (IN)

(21) Appl. No.: 13/907,387

(22) Filed: May 31, 2013

Related U.S. Application Data
(63) Continuation of application No. 13/494,428, filed on Jun. 12, 2012.

(51) Int. Cl. G06Q 10/06

(52) U.S. Cl. CPC G06Q 10/06311
USPC 705/301

(57) ABSTRACT

A knowledge base is built for a case management system. A case content comprising all incoming documents of the case and all collaborative activities associated with the case is built. Text analytics are performed on the case content. An identification of all the knowledge workers working on the case is linked to the case content. The case content, the text analytics and the identification of all knowledge workers working on the case are then stored in a memory.

### BACKGROUND

The present invention relates in general to case management, and, in particular, to leveraging analytics to propose context sensitive workflows for case management solutions.

Business Process Outsourcing (BPO) companies hire knowledge workers (case workers) to process incoming cases pertaining to their industry. Every incoming case is different and cannot be sequentially modeled by a system. Advanced Case Management solutions offer flexibility to knowledge workers by providing tools and tasks that can be appropriately selected and run while processing a case toward completion. To process a new case, the knowledge worker will have at his disposal a large set of tasks to choose from in order to process a case successfully. The tasks to be performed, to move a case to completion state, fall under a set of mandatory as well as optional (ad-hoc) tasks. Choosing the right set of optional tasks becomes very crucial in the final outcome of processing a case. In addition, selecting the right set of tasks is time consuming and also prone to errors.

### BRIEF SUMMARY

According to one embodiment of the present invention, a method builds a knowledge base for a case management system. A case content comprising all incoming documents of the case and all collaborative activities associated with the case is built. Keyword textual analysis is performed on the incoming documents. An identification of all the knowledge workers working on the case is linked to the case content. The case content, the text analytics and the identification of all knowledge workers working on the case are then stored in a memory.

According to one embodiment of the present invention, a system builds a knowledge base for a case management system. Instructions build a case content comprising all incoming documents of the case and all collaborative activities associated with the case. Instructions perform keyword textual analysis of the incoming documents. Instructions link an identification of all knowledge workers working on the case to the case content. Instructions store the case content, the text analytics and the identification of all knowledge workers working on the case.

According to one embodiment of the present invention, a computer program product builds a knowledge base for a case management system. Computer readable program code is configured to build a case content comprising all incoming documents of the case and all collaborative activities associated with the case. Computer readable program code is configured to perform keyword textual analysis of the incoming documents. Computer readable program code is configured to link an identification of all knowledge workers working on the case to the case content. Computer readable program code is configured to store the case content, the text analytics and the identification of all knowledge workers working on the case.

### BRIEF DESCRIPTION OF THE SEVERAL VIEWS OF THE DRAWINGS

FIG. 1 is one example of a computer system 10 suitable for executing an embodiment of the present invention;

FIG. 2 illustrates an overview of an embodiment of the present invention;

FIG. 3 illustrates an output as a suggested set of optional tasks that need to be invoked in accordance with an embodiment of the present invention;

FIG. 4 illustrates criteria that may be used to arrive at a knowledge worker's expertise level in accordance with an embodiment of the present invention; and

FIG. 5 illustrates an OLAP schema in accordance with an embodiment of the present invention.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable media (memory or device) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

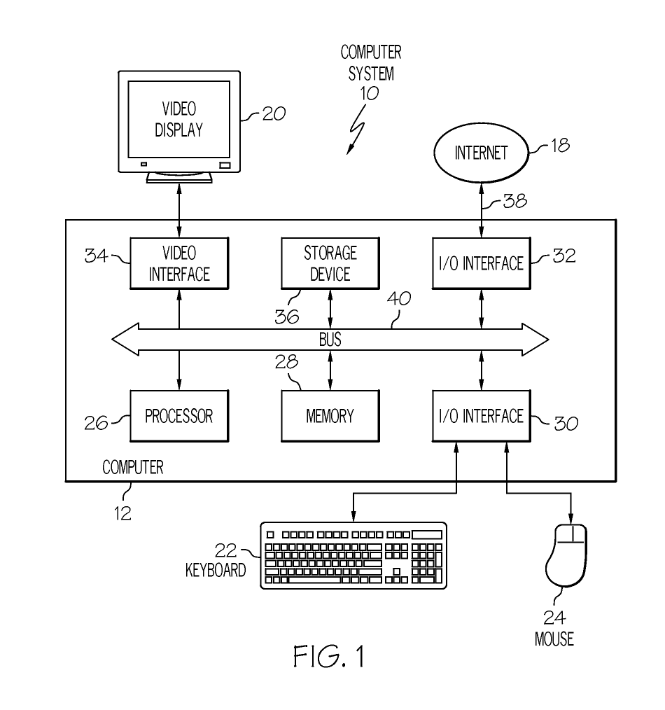

FIG. 1 is one example of a computer system 10 suitable for executing computer software for building a knowledge base for a case management system. Other processing devices which are suitable for executing the software can be a wireless telephone, personal assistant device (PDA), portable computer, smart remote control device, or any other processing devices that can execute such software.

The computer system 10 is of a type that executes under a suitable operating system installed on the computer system 10. The components of the computer system 10 include a computer 12, a keyboard 22, mouse 24, and a video display 20. The computer 12 includes a processor 26, a memory 28, input/output (I/O) interfaces 30 and 32, a video interface 34, and a storage device 36.

The processor 26 is a central processing unit (CPU) that executes the operating system and the computer software executing under the operating system. The memory 28 includes random access memory (RAM) and read-only memory (ROM), and is used under direction of the processor 26.

The video interface 34 is connected to a video display 20 and provides video signals for display thereon. User input to operate the computer 12 is provided from the keyboard 22 and mouse 24. The storage device 36 can include a disk drive or any other suitable storage medium, as discussed above. Each of the components of the computer 12 is connected to an internal bus 40 that includes data, address, and control buses, to allow components of the computer 12 to communicate with each other via the bus 40. The computer system 10 can be connected to one or more other similar computers via an input/output (I/O) interface 32 using a communication channel 38 to a network, represented as the Internet 18. One or more servers 19 may be connected to the computer 12 via a network, such as, the Internet 18. The servers 19 may comprise the same physical arrangement as the computer 12 and may be co-located with or a part of the computer 12.

The computer software may be recorded on a computer readable storage medium, in which case, the computer software program is accessed by the computer system 10 from the storage device 36. Alternatively, the computer software can be accessed directly from the Internet 18 by the computer 12. In either case, a user can interact with the computer system 10 using the keyboard 22 and mouse 24 to operate the programmed computer software executing on the computer 12.

The present invention can be explained with reference to a simple example comprising an insurance company that has several business operations that it handles. A case processor job requires verification of an incoming application for insurance from a customer/business operation. The customer submits an application using a form having a specific format. Processing the form is a basic operation that is performed, and it requires a minimum expertise level. However, there will be some advanced operations, like calculating potential insurance claim amounts and the financial risk to the insurance company. Such operations require greater expertise level. Thus, employees of various skill levels may need to become involved with each application for insurance and any subsequent claims. For a claim (or a case) to get processed successfully, the case workers need to complete a required set of work items (or) tasks. Each task has different complexity and requires varying levels of expertise.

The insurance company can classify their employees' expertise level on a scale of 1 to 10, wherein 1 is a new and inexperienced employee and 10 is a seasoned employee with proven skills. The company can also assign their employees based on this expertise level scale. The company can have a rules based mechanism wherein they can increment the expertise level of an employee based on a set of cases that he/she has processed successfully (for example, more than 1000 cases). Another rule could be based on the number of years of employment or on knowledge improvement criteria, for example, certain training in the organization an employee has undergone. Using these techniques the knowledge worker expertise level promotions can be automated.

Every incoming case contains documents that are associated with it. The incoming documents can be the actual application form that is filled by the customer. Another document could be the written email document that talks about an accident and a description of claim details. In addition, proofs, for example, address, social security number (SSN), and identity are among the documents that are typically submitted as associated with a case.

During a case processing, there are some collaborative activities/discussions that happen between the knowledge workers. There will also be comments added by knowledge workers for each task that gets processed. Each task (or) work item will be processed by a case worker. During processing of a task/work item the case worker can add his/her comments to the case so that it will be available for subsequent case workers who process the next work item. All these documents constitute the content of a case and is used to build a knowledge base. This knowledge base will contain the context of a case.

Every BPO organization has people who are at different expertise level. They include subject matter experts, domain experts, experienced people, and inexperienced people. Based on some type of defined criteria, expertise levels can be assigned for various knowledge workers. This information also becomes part of the proposed knowledge base.

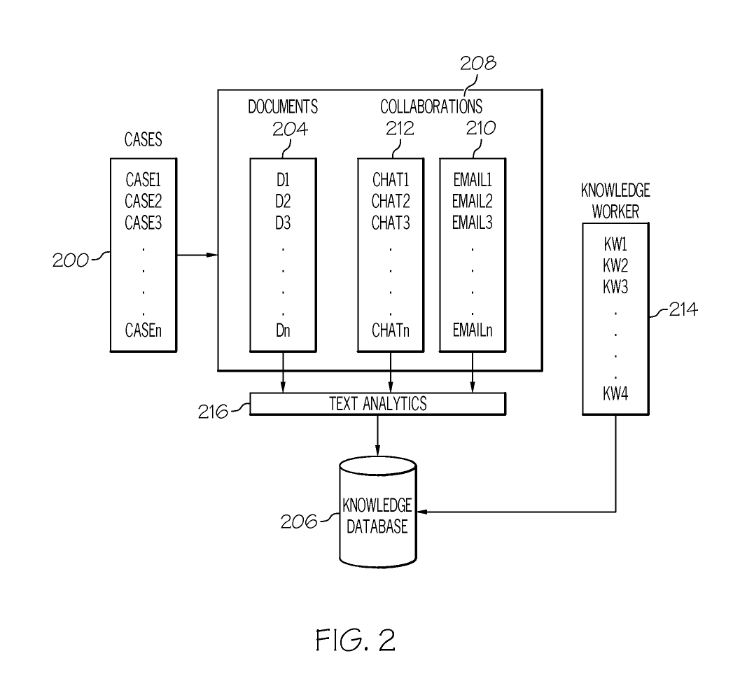

With reference now to FIG. 2, the present invention creates a knowledge base 206 of cases 200. For each incoming case 200, the following data is captured:
1. Discussions and collaboration 208: The discussions/collaborations, like emails 210 and chat scripts 212, that occur between the assigned knowledge workers 214 while processing a case, are stored;
2. Text analytics results 216 of case documents 204: As part of this phase, the documents 204 attached to the incoming cases 200 are crawled through with a computer program, and text analysis is performed to get the keywords, phrases, etc. from the documents; and
3. The expertise level of the knowledge workers 214 who processed the case.

In order to process a case towards completion, a set of both mandatory and optional tasks must be run. Case processing=[MT1−MTn]+[OT1−OTn] where,

### MT=Mandatory Task; and

### OT=Optional Task

For example, in an insurance claims processing, verifying the customer's insurance validity is generally done for all incoming cases. Similarly, customer detail's verification is also required. These are some examples of mandatory tasks to be performed for any case before moving it to completion. However, police verification and approval may be an optional task and is not required in all cases. It is up to the case worker's judgment to initiate or not initiate this task since it is an optional task. Also, verification from the field agent and coming up with the insurance amount may be required in cases where the claimed insurance amount is greater than some predetermined value (say claimed amount is more than 1000 USD). Here, verifying the customer's insurance validity and customer detail's verification are mandatory tasks, whereas police verification and verification from the field agent are optional tasks.

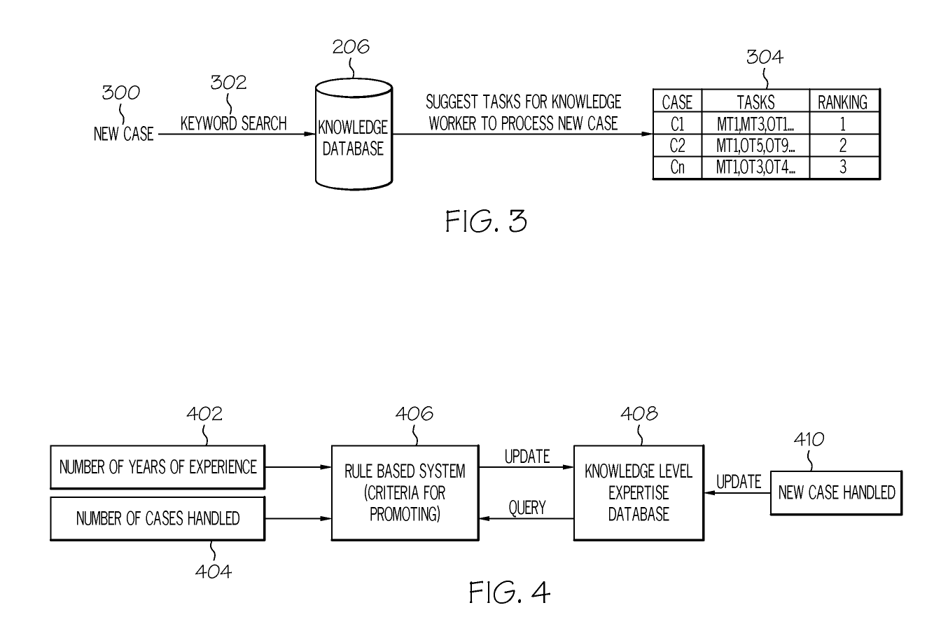

Referring to FIG. 3, as part of the present invention, the output is the suggested set of optional tasks that need to be invoked. For any new incoming case 300, the existing knowledge database 206 (that is built as per FIG. 2) is searched 302. The knowledge worker provides keywords of interest, and a look-up is done through the prior knowledge base 206 which returns a list of cases 304 that are similar to the new case 300. In addition, the present invention proposes ranking methods for use in ranking similar cases. Such rankings may serve as a suggestion to the knowledge worker.

The knowledge worker expertise level is an important criteria or parameter that should be considered while ranking similar cases. Referring to FIG. 4, the expertise levels may be, for example, integers between 1 to 10, where 1 is the minimum expertise level and 10 is the highest expertise level. Depending upon the knowledge worker's expertise level, proper weights are given before suggesting or ranking similar cases from the knowledge base. In addition, the present invention can be used to build and monitor the expertise levels of knowledge workers. For example, the following criteria may be used to arrive at a knowledge worker's expertise level:

1. Number of years of experience 402;

2. Number of cases that have been handled 404 by the knowledge worker.

Initially, a knowledge worker will have an expertise level of 1. A set of rules 406 can be defined by the organization that will be used to build and update the expertise levels of the existing knowledge workers in a database 408; and

3. Updates are also made to the database 408 for each new case handled 410 by the knowledge worker.

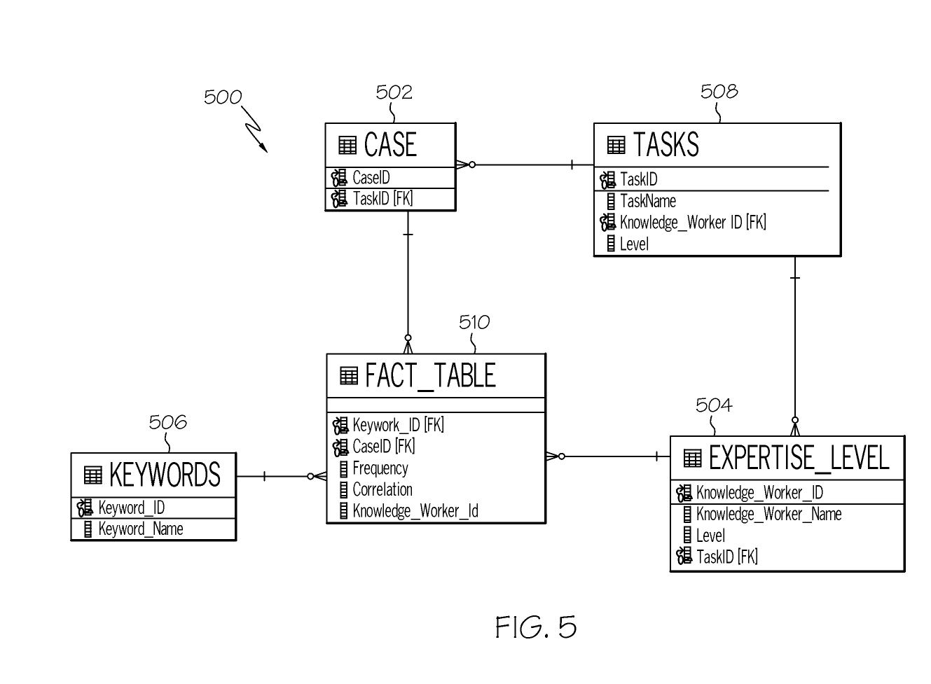

Referring to FIG. 5, the knowledge database 206 (FIG. 2) of the present invention will typically contain a set of relational database tables that store the required information. The tables form an OLAP schema 500, one example of which will now be described. A Case table 502, for example, Sample Case: Table 1, contains a CaseID and a list of TaskIDs that are run as part of every case that is being processed:

TABLE 1
Sample Case:

| Case ID | Task ID |
|---|---|
| 1 | 1, 3, 5 |
| 2 | 1, 3, 4 |
| 3 | 1, 5 |

An Expertise Level table 504, for example, Expertise Level: Table 2, contains the list of knowledge workers and their expertise level. Expertise level can, for example, take values from 1 to 10 (1 being the minimum and 10 being the maximum expertise levels):

TABLE 2
Sample Expertise_Level:

| KWID | KW_Name | Level |
|---|---|---|
| 1 | workerA | 2 |
| 2 | workerB | 6 |
| 3 | workerC | 10 |
| 4 | workerD | 1 |
| . | . | . |
| . | . | . |
| . | . | . |

A Keyword table 506, for example, Sample Keywords: Table 3, contains a list of all the keyword IDs and the keyword names that are obtained as part of a text analysis for the documents that are associated with each case:

TABLE 3
Sample Keywords:

| Keyword ID | Keyword Name |
|---|---|
| 1 | legal |
| 2 | review |
| 3 | collect . . . check |
| 4 | compliance |
| 5 | . . . |
| . . . | . . . |

A Tasks table 508, for example, Sample Tasks: Table 4, contains the TaskID, TaskName, and the knowledge worker (KW_ID) and expertise level at the time of processing the case.

TABLE 4
Sample Tasks:

| Task ID | Task Name | KW_ID | Level |
|---|---|---|---|
| 1 | MT1 | 2 | 2 |
| 2 | OT2 | 3 | 4 |
| 3 | OT3 | 1 | 5 |
| 4 | MT2 | 3 | 2 |
| 5 | OT2 | 4 | 1 |
| 6 | . | . | . |
| . . . | . | . | . |
| | . | . | . |

The FACT_TABLE 510, for example, Sample FACT_Table: Table 5, contains the FKEY (references to the base tables Case 502 and Keywords 506) along with the frequency of occurrences, correlation of the keyword against each case that gets processed, and the knowledge worker ID of each knowledge worker that worked on the case.

TABLE 5
Sample FACT_Table:

| Case ID | Keyword ID | Frequency | Correlation | KW_ID |
|---|---|---|---|---|
| 1 | 1 | 3 | 2.3 | 2 |
| 1 | 3 | 2 | 1.8 | 3 |
| 1 | 2 | 1 | 1.0 | 1 |
| 1 | 4 | 2 | 1.9 | 3 |
| 1 | 9 | 3 | 2.1 | 4 |
| 1 | 7 | 1 | 3.0 | 8 |
| 2 | 1 | 11 | 5.0 | 18 |
| 2 | . | . | . | . |
| | . | . | . | . |
| | . | . | . | . |

A knowledge worker, after going through the documents attached to a new incoming case, searches for the keywords of interest. The FACT_TABLE 510 is queried for the keyword. The list of cases in which the frequency and correlation are matched are retrieved, and they are, in turn, ranked. From the top ranked similar cases, the tasks which were run, therein, are obtained. For each task that is run, the knowledge worker's expertise level is used to calculate the final ranking of similar cases. Depending upon the knowledge worker's expertise level, appropriate weight is given to calculate the best suggested case to use from the history of cases.

There are 3 levels of ranking for the list of cases:

Case Ranking 1st Level:
The first level of ranking is a function of frequency and correlation of the searched keyword.
Suggested_Cases_List_{—}1=function(keyword frequency, keyword correlation of searched keyword). As part of this ranking, the relevant case ids are obtained. From the CaseID, the tasks that were executed as part of this case are retrieved. This will define the path taken to process the suggested cases.

Case Ranking 2nd Level:
The second level of ranking uses the knowledge level of the workers who have processed the individual tasks. If the tasks in a case are processed by expert knowledge worker(s), then they are ranked higher.
Suggested_Cases_List_{—}2=function(Suggested_Cases_List_{—}1, knowledge level of the worker who processed the tasks).

Case Ranking 3rd Level:
Suggested_Cases_List_{—}3=function(Suggested_Cases_List_{—}2, number of cases handled by the knowledge worker).

An organization can define a rule based criteria for promoting the expertise levels of the knowledge workers. For example, the number of years of experience, and/or total number of cases handled can form a rule base. For every case that is processed by the knowledge worker, the knowledge worker database table is updated to reflect the total cases that a knowledge worker has handled. Periodic queries to the rule based system are done in order to find out if the promotion criteria has been met. If the promotion criteria is met, then the expertise level is incremental. This system provides a way to automatically build and monitor the expertise level of knowledge workers in an organization.

The present invention provides at least the following advantages over the prior art:
1. A knowledge base of cases is built based upon case content and knowledge workers behavior/expertise level;
2. Tasks/Workflows are proposed based upon the content of the case and a prior knowledge base; and
3. The expertise level of knowledge workers is automatically expanded upon and monitored (can used for ranking of similar cases).

The corresponding structures, materials, acts, and equivalents of all elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method of building a knowledge base for a case management system, comprising:
building a case content comprising all incoming documents of the case and all collaborative activities associated with the case;
performing, with a processor, keyword textual analysis of said incoming documents;
linking an identification of all knowledge workers working on the case to said case content; and
storing, in a memory, said case content, said textual analysis, and said identification of all knowledge workers working on the case.

2. The method of claim 1, further comprising searching the knowledge base for a list of suggested cases similar to a new incoming case in order to assist a knowledge worker on how to process said new case.

3. The method of claim 2, wherein said knowledge workers working on the case are further classified by an expertise level.

4. The method of claim 3, further comprising ranking said suggested cases by their similarity to said new case, said ranking based on keyword textual analysis performed on said suggested cases and an expertise level of knowledge workers who worked on said suggested cases.

5. The method of claim 3, wherein said expertise level of said knowledge worker is automatically updated based on a number of cases processed successfully by said knowledge worker, a number of years of experience of said knowledge worker, and knowledge improvement criteria.

6. The method of claim 1, wherein said collaborative activities associated with the case comprise comments added to the case by said knowledge workers working on the case.

7. The method of claim 1, wherein said collaborative activities associated with the case comprise at least one of emails and electronic chat text between said knowledge workers working on the case.
